(19) United States
(12) Patent Application Publication
(10) Pub. No.: US 2025/0275885 A1
(43) Pub. Date: Sep. 4, 2025

(54) NECK MASSAGE DEVICE WITH DUAL ARC-SHAPED RIGID CLAMPING PLATES

(71) Applicant: Zhijun PENG, Foshan (CN)

(72) Inventor: Zhijun PENG, Foshan (CN)

(21) Appl. No.: 18/979,678

(22) Filed: Dec. 13, 2024

(30) Foreign Application Priority Data
Mar. 3, 2024 (CN) 2024102383011

(51) Int. Cl. A61H 23/02

(52) U.S. Cl. CPC A61H 23/0245; A61H 2201/1207; A61H 2205/04

(57) ABSTRACT

A neck massage device, including two arc-shaped rigid clamping plates symmetrically arranged side by side, at least one first binding belt, a second binding belt, two ultrasonic vibrators, and some massage heads. Rear ends of the two arc-shaped rigid clamping plates are connected together by connecting to two ends of each first binding belt respectively; front ends of the two arc-shaped rigid clamping plates are provided with bent portions respectively; two ends of the second binding belt are connected to the two bent portions respectively; the massage heads are detachably and adjustably mounted on the two arc-shaped rigid clamping plates via threaded connection; the two ultrasonic vibrators are mounted on the two arc-shaped rigid clamping plates respectively.

### BACKGROUND OF THE INVENTION

The present invention relates to the field of massaging healthcare instruments, and in particular, to a neck massage device with dual arc-shaped rigid clamping plates.

Cervical vertebra is one of two major hubs of the human body, and it is a key hub connecting the head and the body, and is the only channel for nerves and blood vessels to pass through from the head. In addition, cervical vertebra is the smallest among the spinal bones but with the greatest flexibility and moves most frequently, and it is the section in the spinal bones that bears relatively a heavy load. With the continuous development of economy and society, more people are engaged in long hours of desk work, such as those in the IT sectors and Internet industries. During work, body and neck maintain a same posture for a long period of time that leads to muscle stiffness and poor blood flow; accordingly, strain will be developed on the cervical vertebra which may elicit cervical disc herniation, hyperostosis or inflammation of the cervical vertebra, and cause prevalence and high probability of cervical spondylosis which may also accompany a series of serious complications such as bradypsychia, memory decline, headache, and neuropathic pain, that may traumatize a person both physically and spiritually and greatly affect their work and life. Therefore, healthcare of the cervical vertebra is of great importance.

In view of the above, the applicant of the present invention has developed a prior art disclosed in CN116807862A (application No. 202010265821.3) filed Apr. 7, 2020 and titled “ADJUSTABLE ULTRASONIC CERVICAL VERTEBRA MASSAGER WITH AIR BAG ENCLOSING FUMIGATION TREATMENT AREA”. The massager according to this prior art patent mainly comprises a front jaw bearing part, a rear neck binding belt part, an inflatable air bag belt, and a plurality of ultrasonic massage heads each provided with an ultrasonic motor or an ultrasonic transducer. During use of the massager, the inflatable air bag belt is inflated, so that an inner side surface of the rear neck binding belt part can be well attached to the neck corresponding to the cervical vertebra of the user. Also, high-frequency ultrasonic massage is performed on muscles of the human body with the ultrasonic massage heads, so that high-frequency ultrasonic vibratory massage can go deep into the muscles of the human body, thereby accelerating blood flow and circulation of the human body, quickly rejuvenating blood cells, promoting metabolism, and enhancing self-immunity of the human body.

Although the aforementioned technical solutions of the prior art patent of the applicant can achieve therapeutic effect and maintain the general well-being of the cervical vertebra, the technical solutions has the following deficiencies: Firstly, the neck massage device is provided with a front jaw bearing part to prevent the rear neck binding belt part from binding too tightly on the trachea area of the neck, however, the front jaw bearing part will increase the entire size of the neck massage device, in other words, the neck massage device is not small enough and it is not convenient to wear; during use, movement of the head is also significantly limited from moving freely. Secondly, mounting positions of the ultrasonic massage heads are relatively fixed; the positions for vibration cannot be adjusted freely by the user according to actual use requirements; as a result, the neck massage device has limited flexibility of use. Thirdly, one ultrasonic massage head needs to be provided for each high-frequency vibration position, and at least one ultrasonic motor or ultrasonic transducer needs to be provided in each ultrasonic massage head. As a result, there are quite many ultrasonic motors or ultrasonic transducers being used on the cervical vertebra massager, and massive wiring is thus required, leading to a complex overall structure and great manufacturing difficulty. Moreover, a plurality of ultrasonic motors or ultrasonic transducers used together will consume a large amount of electric energy, and the inflatable air bag belt also consumes electric energy during work; consequently, the cervical vertebra massager as a whole consumes a lot of electricity and is not energy-efficient enough. Based on the foregoing deficiencies, the applicant considers that a cervical vertebra massager of this type need to be further improved to better satisfy user's need for daily healthcare via massage.

### BRIEF SUMMARY OF THE INVENTION

To resolve the foregoing problems and deficiencies, the present invention provides a neck massage device with dual arc-shaped rigid clamping plates. The neck massage device of the present invention is small in size and convenient to wear. During massage, the user can still move his/her head freely. In addition, the neck massage device of the present invention provides a clearance to avoid a trachea area corresponding to the neck of the human body, thereby avoiding impact on breathing. Moreover, all massage heads on a same arc-shaped rigid clamping plate can be driven synchronously by powering up one ultrasonic vibrator to perform high-frequency vibratory massage, thereby reducing a number of electric elements used and reducing the needs for wiring, simplifying the structure and manufacturing process, and saving electric energy. Further, the massage heads are detachably mounted on the arc-shaped rigid clamping plates. Therefore, the massage heads can be detached to adjust their mounting positions, thereby allowing higher flexibility and greater convenience of use of the neck massage device to meet the massage requirements of different users on different neck positions.

The present invention is achieved as follows: A neck massage device, comprising two arc-shaped rigid clamping plates symmetrically arranged side by side; rear ends of the two arc-shaped rigid clamping plates are connected to two ends of at least one first binding belt respectively, so that the two arc-shaped rigid clamping plates are connected as a whole; a work cavity is formed between the two arc-shaped rigid clamping plates; front ends of the two arc-shaped rigid clamping plates are provided with bent portions respectively; the bent portions bend outwardly; a clearance exists between the bent portions; the neck massage device also comprises a second binding belt; two ends of the second binding belt are connected to the two bent portions respectively so as to narrow and tighten the work cavity between the two arc-shaped rigid clamping plates; the neck massage device also comprises two ultrasonic vibrators and a plurality of massage heads; a plurality of through holes spaced apart from one another evenly by a same distance are formed on each of the two arc-shaped rigid clamping plates; each of the massage heads is detachably and adjustably mounted in a respective one of the through holes via threaded connection; the two ultrasonic vibrators are mounted on the two arc-shaped rigid clamping plates respectively, and when powered on, each of the two ultrasonic vibrators drives all the massage heads on a corresponding arc-shaped rigid clamping plate synchronously to perform high-frequency vibratory massage.

Further, a concave cavity is formed in the middle of each of the two arc-shaped rigid clamping plates; a corresponding ultrasonic vibrator is disposed inside each concave cavity; and a cover for protecting the corresponding ultrasonic vibrator is provided to cover an opening of each concave cavity.

Further, each of the massage heads comprises a massage part with a surface featuring a plurality of massage protrusions, a screw part connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

Further, a drug supply channel is provided on each of the massage heads penetrating from the surface of the massage part provided with the plurality of massage protrusions all the way through two ends of the screw part along an axial direction of the screw part; one of the two ends of the screw part distal from the massage part is also provided with an interface part connected to the drug supply channel.

The present invention has the following beneficial effects: (1) Two arc-shaped rigid clamping plates are used in the present invention, so that the neck massage device can correspond to the arc shapes of both sides of the neck. Therefore, the neck massage device can be worn on the neck very conveniently and enclose the neck so as to perform ultrasonic vibratory massage around the neck. Moreover, bent portions are provided so that a distance between the second binding belt and the work cavity can be widened to prevent the second binding belt from binding the trachea area of the neck. In addition, a clearance is provided so that the neck massage device can avoid the trachea area of the neck and will not vibrate the trachea area of the neck, thereby preventing impact on breathing. Compared with the prior art, the neck massage device using the above technical solutions is characterized in that no front jaw bearing part is required, so that the neck massage device of the present invention is very small in size and convenient to wear; and during massage, the user can still move his/her head freely. (2) According to the neck massage device of the present invention, the arc-shaped rigid clamping plates are driven to vibrate at a high frequency by powering on respective ultrasonic vibrators, so that all massage heads on a same arc-shaped rigid clamping plate are driven synchronously by a corresponding ultrasonic vibrator to perform high-frequency vibratory massage, thereby greatly reducing the quantities of ultrasonic vibrators to be used and the wiring required, simplifying the structure and manufacturing process, and saving electric energy. (3) Because the massage heads are adjustably mounted in through holes in the arc-shaped rigid clamping plates via threaded connection, when the user wears the neck massage device, the force of the massage heads pressing against a body part of the user can be adjusted by screwing in and out the massage heads relative to the through holes. Therefore, the massage heads can press tightly against the body to provide a high-frequency ultrasonic vibratory massage with a relatively strong force. This allows the user to adjust the pressing force of the massage heads based on his/her own needs, so that the neck massage device can meet use requirements of a majority of people and has a wider scope of utility. (4) Because the massage heads are detachably mounted in the through holes in the arc-shaped rigid clamping plates via threaded connection, the massage heads can be detached and mounted in other through holes at the positions corresponding to the body parts that require massage. Therefore, the objective of adjusting the vibration position freely is achieved; use of the neck massage device is very versatile and convenient; and massage requirements of users for different body parts can be met effectively.

### BRIEF DESCRIPTION OF THE DRAWINGS

FIG. 1 is a front perspective structural view of a neck massage device with dual arc-shaped rigid clamping plates according to the present invention.

FIG. 2 is a rear perspective structural view of the neck massage device with dual arc-shaped rigid clamping plates according to the present invention.

FIG. 3 is a cross sectional view from a top plan perspective of the neck massage device with dual arc-shaped rigid clamping plates according to the present invention.

### DETAILED DESCRIPTION OF THE INVENTION

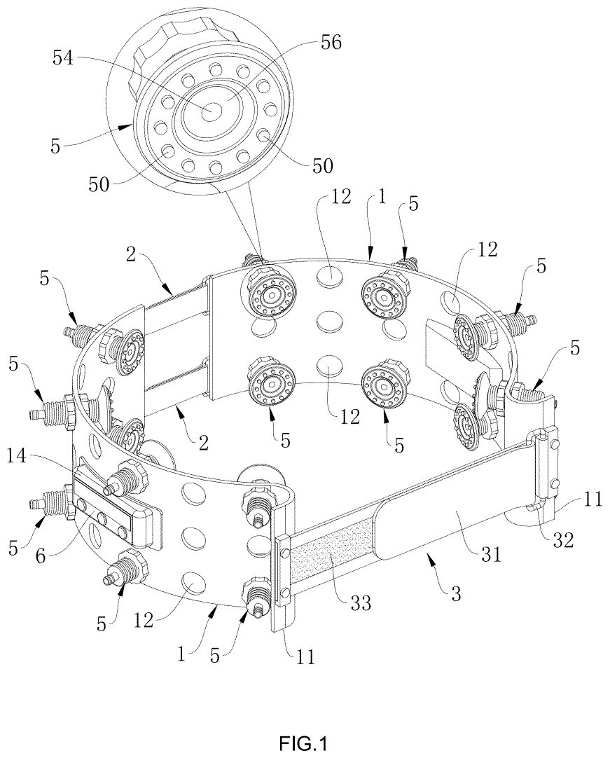

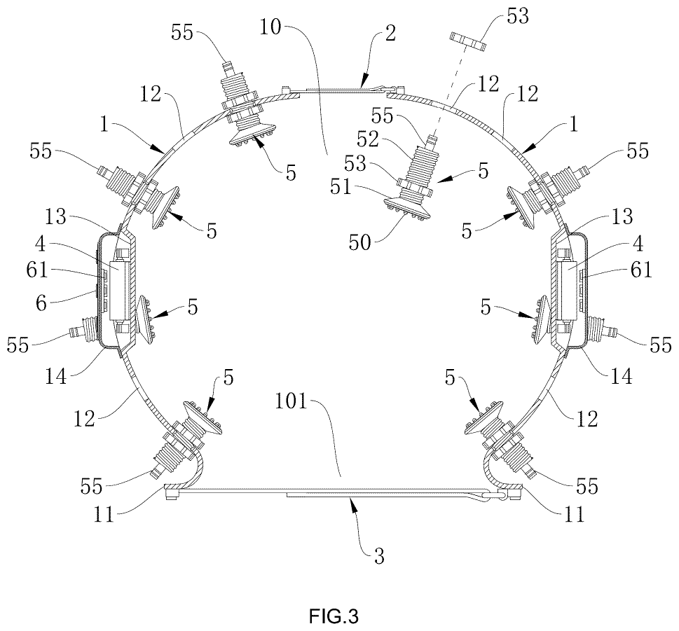

As shown in FIG. 1 and FIG. 3, the present invention provides a neck massage device having dual arc-shaped rigid clamping plates, comprising two arc-shaped rigid clamping plates 1 symmetrically arranged side by side; rear ends of the two arc-shaped rigid clamping plates 1 are connected to two ends of at least one first binding belt 2 respectively, so that the two arc-shaped rigid clamping plates 1 are connected as a whole; a work cavity 10 is formed between the two arc-shaped rigid clamping plates 1; front ends of the two arc-shaped rigid clamping plates 1 are provided with bent portions 11 respectively; the bent portions 11 bend outwardly; a clearance 101 exists between the bent portions 11. The neck massage device also comprises a second binding belt 3; two ends of the second binding belt 3 are connected to the two bent portions 11 respectively, so that the work cavity 10 between the two arc-shaped rigid clamping plates 1 can be narrowed and tightened. The neck massage device also comprises two ultrasonic vibrators 4 and a plurality of massage heads 5; a plurality of through holes 12 spaced apart from one another evenly by a same distance are formed on each of the two arc-shaped rigid clamping plates 1; each of the massage heads 5 is detachably and adjustably mounted in a respective one of the through holes 12 via threaded connection; the two ultrasonic vibrators 4 are mounted on the two arc-shaped rigid clamping plates 1 respectively, and when powered on, each of the two ultrasonic vibrators 4 drives all the massage heads 5 on a corresponding arc-shaped rigid clamping plate 1 synchronously to perform high-frequency vibratory massage.

The neck massage device of the present invention is small in size and convenient to wear. During massage, the user can still move his/her head freely. In addition, the neck massage device of the present invention provides a clearance to avoid a trachea area corresponding to the neck of the human body, thereby avoiding impact on breathing. Moreover, all massage heads on a same arc-shaped rigid clamping plate can be driven synchronously by powering up one ultrasonic vibrator to perform high-frequency vibratory massage, thereby reducing a number of electric elements used and reducing the needs for wiring, simplifying the structure and manufacturing process, and saving electric energy. Further, the massage heads are detachably mounted on the arc-shaped rigid clamping plates. Therefore, the massage heads can be detached to adjust their mounting positions, thereby allowing higher flexibility and greater convenience of use of the neck massage device to meet the massage requirements of different users on different neck positions.

As shown in FIG. 3, a concave cavity 13 is formed in the middle of each of the two arc-shaped rigid clamping plates 1; the ultrasonic vibrators 4 are disposed in the concave cavities 13 respectively; and covers 14 for protecting the ultrasonic vibrators 4 are provided to cover openings of the concave cavities 13 respectively. Accordingly, the ultrasonic vibrators 4 are not exposed to an external environment, and the surface tidiness and safety of use of the neck massage device are enhanced. The ultrasonic vibrators 4 can be encapsulated effectively by using the covers 14 to achieve a dust-proof effect. Moreover, during use of the neck massage device, the human body cannot touch the ultrasonic vibrators 4, so that safety of use of the neck massage device is improved. In addition, the concave cavity 13 formed in the middle of each of the arc-shaped rigid clamping plates 1 allows the high-frequency vibration of the ultrasonic vibrator 4 on each of the arc-shaped rigid clamping plates 1 to be uniformly transferred to all positions of the corresponding arc-shaped rigid clamping plate 1, thereby ensuring that the vibration kinetic energy applied to the massage heads 5 on the corresponding arc-shaped rigid clamping plate 1 will be nearly the same, thereby ensuring that all massaging zones on the neck massage device can provide a relatively balanced ultrasonic vibratory massage effect.

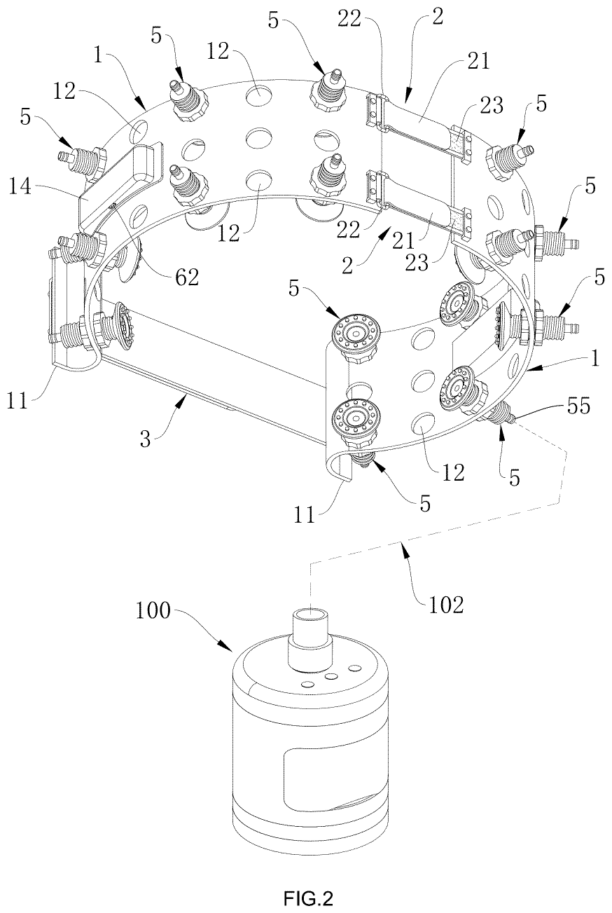

To facilitate the user to use the neck massage device conveniently, as shown in FIG. 1, a control panel 6 is disposed on one of the covers 14; a control circuit board 61 electrically connected to a corresponding ultrasonic vibrator 4 and said control panel 6 is disposed on an inner side of each of the covers 14. As shown in FIG. 1 and FIG. 2, in the present invention, the control panel 6 may be disposed on one of the two arc-shaped rigid clamping plates 1; the ultrasonic vibrator 4 on another arc-shaped rigid clamping plate 1 that is not provided with the control panel 6 may be connected to the control panel 6 via wired or wireless connection so that the control panel 6 also controls the ultrasonic vibrator 4 on said another arc-shaped rigid clamping plate 1 not provided with the control panel 6. Each of the ultrasonic vibrators 4 is an ultrasonic vibration motor or an ultrasonic transducer. When the ultrasonic transducer is used, each control circuit board 61 of the present invention is further provided with an ultrasonic generator or an ultrasonic generating circuit; and the ultrasonic generator or the ultrasonic generating circuit drives the corresponding ultrasonic transducer to work.

As shown in FIG. 2, to facilitate power supply to different electric elements, each of the covers 14 is further provided with a power interface 62 electrically connected to the corresponding control circuit board 61. Of course, the neck massage device of the present invention can also be provided with storage batteries for power supply. In addition, a Bluetooth® communication module or a Wi-Fi® communication module can also be provided in each control circuit board 61, and corresponding application software can be developed and installed on a smartphone so that the massage device of the present invention can be controlled to operate by using the smartphone. Alternatively, an infrared communication module can be provided to each control circuit board 61, thereby allowing the neck massage device to be operated using a remote controller.

To ensure that the massage heads 5 are simple in structure, easy to implement, and convenient to produce and manufacture, as shown in FIG. 3, each of the massage heads 5 comprises a massage part 51 with a surface featuring a plurality of massage protrusions 50, a screw part 52 connected to the massage part 51, and two tightening nuts 53; the screw part 52 is selectively inserted into one of the through holes 12, and the two tightening nuts 53 are screwed onto the screw part 52 on both sides of said one of the through holes 12 respectively, thereby allowing the screw part 52 to be detachably and adjustably installed into said one of the through holes 12. Through clamping by the two tightening nuts 53, each of the massage heads 5 can be securely installed on a corresponding arc-shaped rigid clamp plate 1, making it less likely to be loosen or detached. As shown in FIG. 3, during detachment, it is only necessary to unscrew the tightening nut 53 proximal to an outer end of the screw part 52 from the screw part 52, so that the screw part 52 can be detached from the through hole 12 and thereby removing the entire massage head 5 from the corresponding arc-shaped rigid clamp plate 1. When it is necessary to adjust the massage head 5 to press against the human body, adjustment can be achieved simply by holding the massage part 51 or the screw part 52 and then screwing the two tightening nuts 53 to adjust the positions of the two tightening nuts 53.

To increase the functionality of the neck massage device of the present invention, as shown in FIG. 1, FIG. 2, and FIG. 3, a drug supply channel 54 is provided on each of the massage heads 5 penetrating from the surface of the massage part 51 provided with the plurality of massage protrusions 50 all the way through two ends of the screw part 52 along an axial direction of the screw part 52; one of the two ends of the screw part 52 distal from the massage part 51 is also provided with an interface part 55 connected to the drug supply channel 54. Through the design of the drug supply channel 54 and the interface part 35, the neck massage device of the present invention can be sold together with a drug supply device 100. The drug supply device 100 is selectively connected to at least one interface part 55 through at least one pipeline 102, and drug solutions can be converted to gaseous drug by the drug supply device which then pumps the gaseous drug to at least one corresponding drug supply channel 34 through which the gaseous drug is sprayed onto the human body, thereby achieving a therapeutic effect through steaming of the gaseous drug. An example of the drug supply device 100 is mentioned in CN111939045A (application No. 201910413695.9) also proposed by the inventor of the present invention.

As shown in FIG. 1, the massage part 51 is also provided with a recess 56, and the drug supply channel 54 penetrates through a bottom surface of the recess 56; the massage protrusions 50 are arranged circumferentially around the recess 56. Through these designs, an outlet of the drug supply channel 54 is prevented from being blocked by the skins and flesh of human body which may move and hence block the drug supply channel 54 when the massage part 51 presses against the human body to perform massage. Through the arrangement of the recess 56, the drug supply channel 54 is spaced apart from the human body to effectively prevent blockage of the drug supply channel 54. By arranging the massage protrusions 50 circumferentially around the recess 56, gaps between adjacent massage protrusions 50 facilitate the outward diffusion of the gaseous drug, thereby ensuring smooth outflow of the gaseous drug.

As shown in FIG. 2, said at least one first binding belt comprises two first binding belts 2, so that the two arc-shaped rigid clamping plates 1 can be stably connected together and are not easy to get loose or wobble.

To ensure that each first binding belt 2 is simple in structure and easy to implement, as shown in FIG. 2, each first binding belt 2 comprises a first connecting belt 21 disposed on one of the arc-shaped rigid clamping plates 1, and a first binding belt ring 22 disposed on another one of the arc-shaped rigid clamping plates 1; a first hook and loop fastener 23 is disposed on an outer side surface of the first connecting belt 21; one end of the first connecting belt 21 passes through the first binding belt ring 22 and is then folded back and adhered back to the outer side surface of the first connecting belt 21. “Adhered back to the outer side surface of the first connecting belt 21” implies a known technology where self-adhesion is achieved between a hook portion and a loop portion (which are not particularly shown in the figures) both disposed on the outer side surface of the first hook and loop fastener 23. Due to the structural design, a distance between the two arc-shaped rigid clamping plates 1 can be adjusted, and thus, the neck massage device can adapt to various neck sizes and the range of utility of the neck massage device becomes wider.

To ensure that the neck massage device of the present invention is convenient, simple, and fast to wear, as shown in FIG. 1, the second binding belt 3 comprises a second connecting belt 31 disposed on one of the bent portions 11, and a second binding belt ring 32 disposed on another one of the bent portions 11; a second hook and loop fastener 33 is disposed on an outer side surface of the second connecting belt 31; and one end of the second connecting belt 31 passes through the second binding belt ring 32 and is then folded back and adhered back to the outer side surface of the second connecting belt 31. “adhered back to the outer side surface of the second connecting belt 31” herein implies a known technology where self-adhesion is achieved between a hook portion and a loop portion (which are not particularly shown in the figures) both disposed on the outer side surface of the second hook and loop fastener 33. Due to the structural design, the work cavity 10 can be narrowed and tightened very easily.

During application, a number of the massage heads 5 mounted on the two arc-shaped rigid clamping plates 1 can be increased or decreased by the user according to personal requirements; and the mounting positions of the massage heads 5 on the two arc-shaped rigid clamping plates 1 can also be adjusted freely. Therefore, use of the neck massage device is very versatile and convenient, so that different use requirements of a majority of users can be met.

What is claimed is:

1. A neck massage device, comprising:
two arc-shaped rigid clamping plates symmetrically arranged side by side; rear ends of the two arc-shaped rigid clamping plates are connected to two ends of at least one first binding belt respectively, so that the two arc-shaped rigid clamping plates are connected as a whole; a work cavity is formed between the two arc-shaped rigid clamping plates; front ends of the two arc-shaped rigid clamping plates are provided with bent portions respectively; the bent portions bend outwardly; a clearance exists between the bent portions;
the neck massage device also comprises a second binding belt; two ends of the second binding belt are connected to the two bent portions respectively so as to narrow and tighten the work cavity between the two arc-shaped rigid clamping plates;
the neck massage device also comprises two ultrasonic vibrators and a plurality of massage heads; a plurality of through holes spaced apart from one another evenly by a same distance are formed on each of the two arc-shaped rigid clamping plates; each of the massage heads is detachably and adjustably mounted in a respective one of the through holes via threaded connection; the two ultrasonic vibrators are mounted on the two arc-shaped rigid clamping plates respectively, and when powered on, each of the two ultrasonic vibrators drives all the massage heads on a corresponding arc-shaped rigid clamping plate synchronously to perform high-frequency vibratory massage.

2. The neck massage device of claim 1, wherein a concave cavity is formed in the middle of each of the two arc-shaped rigid clamping plates; a corresponding one of the two ultrasonic vibrators is disposed inside each concave cavity; and a cover for protecting the corresponding one of the two ultrasonic vibrators is provided to cover an opening of each concave cavity.

3. The neck massage device of claim 2, wherein a control panel is disposed on the cover of only one concave cavity; a control circuit board electrically connected to the corresponding one of the two ultrasonic vibrators and said control panel is disposed on an inner side of each cover.

4. The neck massage device of claim 1, wherein each of the massage heads comprises a massage part with a surface featuring a plurality of massage protrusions, a screw part having one end connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

5. The neck massage device of claim 4, wherein a drug supply channel is provided on each of the massage heads penetrating from the surface of the massage part provided with the plurality of massage protrusions all the way through said one end of the screw part along an axial direction of the screw part through another end of the screw part; said another end of the screw part distal from the massage part is also provided with an interface part connected to the drug supply channel.

6. The neck massage device of claim 5, wherein the massage part is also provided with a recess, and the drug supply channel penetrates through a bottom surface of the recess; the plurality of massage protrusions are arranged circumferentially around the recess.

7. The neck massage device of claim 1, wherein said at least one first binding belt comprises two first binding belts.

8. The neck massage device of claim 1, wherein each first binding belt comprises a first connecting belt disposed on one of the two arc-shaped rigid clamping plates, and a first binding belt ring disposed on another one of the two arc-shaped rigid clamping plates; a first hook and loop fastener is disposed on an outer side surface of the first connecting belt; one end of the first connecting belt passes through the first binding belt ring and is then folded back and adhered back to the outer side surface of the first connecting belt.

9. The neck massage device of claim 1, wherein the second binding belt comprises a second connecting belt disposed on one of the bent portions, and a second binding belt ring disposed on another one of the bent portions; a second hook and loop fastener is disposed on an outer side surface of the second connecting belt; and one end of the second connecting belt passes through the second binding belt ring and is then folded back and adhered back to the outer side surface of the second connecting belt.
